(19) United States
(12) Patent Application Publication
(10) Pub. No.: US 2021/0383186 A1
(43) Pub. Date: Dec. 9, 2021

(54) ELECTRONIC CARD AND ELECTRONIC CARD MANUFACTURING METHOD

(71) Applicant: KONA I CO., LTD., Seoul (KR)

(72) Inventor: Sok Soo SHIN, Gimpo-si, Gyeonggi-do (KR)

(21) Appl. No.: 17/284,021

(22) PCT Filed: Jul. 24, 2019
(86) PCT No.: PCT/KR2019/009125

§ 371 Date: Apr. 9, 2021

(30) Foreign Application Priority Data
Oct. 11, 2018 (KR) 10-2018-0121307

(51) Int. Cl. G06K 19/077

(52) U.S. Cl. CPC G06K 19/07745; G06K 19/07733; G06K 19/07705; G06K 19/07722

(57) ABSTRACT

Provided is an electronic card and a manufacturing method therefor, and the electronic card may include: an electronic module which is configured to comprise an electronic circuit and a contact terminal on a thin film and comprises one or more electronic components; a lower core sheet which comprises an electronic module storage portion for storing the electronic module in a shape corresponding to an outer peripheral shape of the electronic module; and a middle core sheet which is stacked on the top of the lower core sheet storing the electronic module, comprises a component storage portion for storing some or all of the one or more electronic components provided in the electronic module, and is configured to have a sheet thickness equal to a thickness of a tallest component among the electronic components.

### TECHNICAL FIELD

The present invention relates to a manufacturing method for an LED electronic card, and more specifically, to an invention in which a high-temperature heating and high-pressure laminating method is used when manufacturing the LED electronic card, the mass production can be performed without damage to LEDs and mounted components, a product does not shrink during manufacture of the LED electronic card, and the LED electronic card is connected to a contact COB terminal, making it possible to use the LED electronic card without a separate power supply.

### BACKGROUND ART

Conventional electronic cards have used a laminating method in which heat and pressure are applied when an inlay sheet is processed by laminating several core sheets according to the thicknesses of LEDs and mounted components.

However, in the conventional method in which heat and pressure are applied, there was a problem that a product is distorted as the laminated core sheets are shrunk and deformed due to high temperature and high pressure generated by thermo-compression bonding, and there was a negative effect that the LEDs and the mounted component are damaged due to the shrinkage of the sheets.

Therefore, taking the above-described problems into consideration, the present applicant has prevented shrinkage from occurring even at a high temperature and prevented the LEDs and the mounted component from being damaged even at a high pressure.

### DISCLOSURE OF THE INVENTION

### Technical Problem

The present invention proposes an electronic card and a manufacturing method for the electronic card, which are devised to solve the problems of component damage and shrinkage in the manufacture of existing electronic cards.

### Technical Solution

The present invention relates to an electronic card and a manufacturing method therefor, wherein the electronic card according to an embodiment of the present invention may comprise: an electronic module which is configured to comprise an electronic circuit and a contact terminal on a thin film and comprises one or more electronic components; a lower core sheet which comprises an electronic module storage portion for storing the electronic module in a shape corresponding to an outer peripheral shape of the electronic module; and a middle core sheet which is stacked on the top of the lower core sheet storing the electronic module, comprises a component storage portion for storing some or all of the one or more electronic components provided in the electronic module, and is configured to have a sheet thickness equal to a thickness of a tallest component among the electronic components.

Optionally, the lower core sheet and the middle core sheet may be made of a thermosetting epoxy resin, and the middle core sheet may be stacked on the top of the lower core sheet such that a contact terminal of the electronic module is exposed through the component storage portion. The middle core sheet and the lower core sheet may be arranged so as to be aligned and completely overlapped by a jig through a plurality of reference holes formed in side portions thereof, and the middle core sheet and the lower core sheet comprising the electronic module may form an inlay sheet through a laminating process at high temperature and high pressure. An embodiment may further comprise: a photo-curable resin applied on the top of the inlay sheet; and one or more printing papers attached above and below the inlay sheet, and a thermosetting resin may be used as an alternative to the photo-curable resin.

Also, the electronic card according to an embodiment of the present invention may further comprise an IC chip mounted in an IC coupling groove so as to be connected to the contact terminal of the electronic module, wherein the IC coupling groove is formed by milling a surface of an upper printing paper and comprises a first coupling groove for accommodating a molding portion protruding from a rear surface of the IC chip and a second coupling groove milled to expose the contact terminal, and wherein, it may be implemented that, when mounted, the IC chip is connected to the contact terminal through a conductive paste adhesive inserted into the second coupling groove.

According to another aspect of the present invention, a manufacturing method for an electronic card may comprise the steps of: forming an electronic circuit and a contact terminal on a thin film and mounting one or more electronic components, thereby forming an electronic module; storing the electronic module in a lower core sheet, wherein the electronic module is stored in an electronic module storage portion having a shape corresponding to an outer peripheral shape of the electronic module; and stacking a middle core sheet on the top of the lower core sheet storing the electronic module, wherein, in the step of stacking the middle core sheet, the middle core sheet is stacked by using a component storage portion formed, so as to penetrate the middle core sheet, in a shape capable of storing some or all of the one or more electronic components provided in the electronic module, and a thickness of the middle core sheet is configured to be equal to a thickness of a tallest component among the electronic components.

Optionally, the lower core sheet and the middle core sheet may be made of a thermosetting epoxy resin, and the middle core sheet may be stacked on the top of the lower core sheet such that a contact terminal of the electronic module is exposed through the component storage portion. Also, the step of stacking the middle core sheet may further comprise arranging the sheets so as to be aligned and completely overlapped by a jig through a plurality of reference holes formed in side portions thereof, wherein the middle core sheet and the lower core sheet comprising the electronic module form an inlay sheet through a laminating process at high temperature and high pressure.

Additionally, the manufacturing method may further comprise the steps of: stacking a transparent glass and a release paper on the bottom of the inlay sheet and applying a photo-curable resin on the top of the release paper; applying a photo-curable resin on the top of the inlay sheet and stacking a release paper and then rolling the same; placing a transparent glass on the top of the release paper and emitting light to the top and bottom of the inlay sheet to cure the photo-curable resins; and separating the release papers and the transparent glasses on the top and bottom. Also, the manufacturing method may further comprise the steps of: attaching an upper printing paper to the top and a lower printing paper to the bottom so as to be aligned to a plurality of reference holes formed in the inlay sheet; and laminating the inlay sheet, to which the upper printing paper and the lower printing paper are attached, at high temperature and high pressure, thereby forming an electronic card sheet. Furthermore, there may be further provided a step of mounting an IC chip in an IC coupling groove so as to be connected to the contact terminal of the electronic module, wherein the IC coupling groove is formed by milling a surface of the upper printing paper and comprises a first coupling groove for accommodating a molding portion protruding from a rear surface of the IC chip and a second coupling groove milled to expose the contact terminal, and wherein, it may be implemented that, when mounted, the IC chip is connected to the contact terminal through a conductive paste adhesive inserted into the second coupling groove.

According to the present invention as described above, an inlay is produced on the inlay sheet 100 by high-temperature high-pressure laminating, an electronic module 12 is photo-cured and fixed by applying a photo-curable resin 22 and then pushing the same with a roller 43, and firm adhesion between the upper and lower printing papers 31 and 32 can be achieved. Even though a laminating method in which high temperature and high pressure are applied is used, mass production of LED electronic cards can be implemented in a state in which LEDs and electronic components mounted on an FPCB are not damaged, and the firm adhesion between the upper and lower printing papers can also be achieved at high temperature and high pressure thereby to minimize the defect rate. Thus, there is an advantage of being able to provide a high-quality LED electronic card with high international competitiveness.

In the existing electronic card, there has been a problem in that components in the electronic card hardly withstand high temperature and high pressure and are thus damaged during processing. In order to solve this problem, the present invention has employed a thermosetting epoxy resin sheet independently invented, and as it has been implemented that a middle core sheet and a lower core sheet made of such a material are to store electronic circuits and components thereon, it has been implemented that an electronic card may be manufactured without damaging the electronic components and the circuits. The thermosetting epoxy resin sheet does not shrink even when laminated compared to PVC constituting an existing card, and is thus suitable for manufacturing electronic cards. By employing such a material, it becomes possible to manufacture the electronic card by stacking all sheets with a large area sheet, and there is an effect that mass production is easily achieved.

### BRIEF DESCRIPTION OF THE DRAWINGS

FIG. 1 shows a configuration of an electronic card according to an embodiment of the present invention.

FIG. 2A shows a front surface of a core sheet of an electronic card according to an embodiment of the present invention.

FIG. 2B shows a front surface of a core sheet to which an electronic module of an electronic card according to an embodiment of the present invention is mounted.

FIG. 3A shows a rear view of a core sheet of an electronic card according to an embodiment of the present invention.

FIG. 3B shows a rear surface of a core sheet to which an electronic module of an electronic card according to an embodiment of the present invention is mounted.

FIG. 4A shows a cross-section of a lower core sheet to which an electronic module of an electronic card according to an embodiment of the present invention is mounted.

FIG. 4B shows a cross-section of a core sheet to which an electronic module of an electronic card according to an embodiment of the present invention is mounted.

FIG. 4C shows a planarization step in a manufacturing method for an electronic card according to an embodiment of the present invention.

FIG. 4D shows a configuration of stacked sheets in an electronic card according to an embodiment of the present invention.

FIG. 5 shows a mass production process in a manufacturing method for an electronic card according to an embodiment of the present invention.

FIGS. 6A and 6B show a COB insertion process in a manufacturing method for an electronic card according to an embodiment of the present invention.

Like reference numerals refer to like elements throughout the several views.

### MODE FOR CARRYING OUT THE INVENTION

The present invention will now be described with reference to the accompanying drawings. The present invention may, however, be embodied in many different forms and thus is not limited to the embodiments described herein. Also, parts irrelevant to the description are omitted in the drawings to make the present invention clear, and the similar reference numerals are designated to the similar components throughout the specification.

Throughout the specification, when a part is referred to as being “connected” to another part, this includes not only the case where it is “directly connected” thereto, but also the case where it is “indirectly connected” thereto with another member therebetween. Also, when a part is described to “include” a certain component, this means that it may further include other components rather than exclude other components unless otherwise specified.

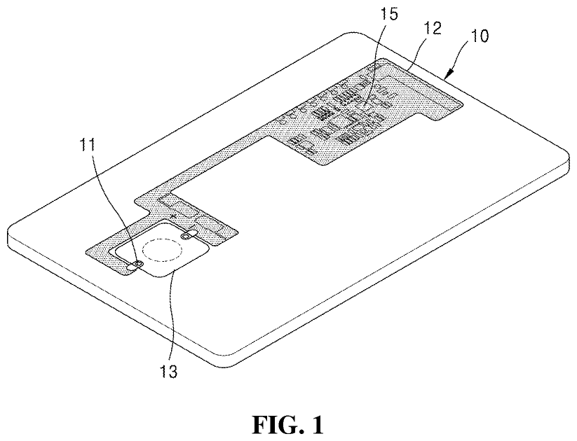

FIG. 1 shows a configuration of an electronic card 10 according to an embodiment of the present invention. The electronic card 10 according to an embodiment of the present invention may include an electronic module 12 on a card plate, and the electronic module 12 may be arranged such that a contact terminal 11 of the electronic module 12 is exposed. The electronic module 12 may include LED module 15, and may include various electronic modules (e.g., BLE communication chips, etc.) in addition to LEDs.

In an embodiment, it may be implemented that an electronic circuit and a copper (Cu) contact terminal 11 are formed in the electronic module 12 by etching a copper plate on a thin film so as to mount the LED 15 and components. Although a portion of the configuration is illustrated in this drawing, the electronic module 12 may include various other electronic components such as a communication module (e.g., BLE, NFC, etc.), a memory, and a processor. Also, each of the electronic components mounted to the electronic module 12 may have various heights. In order to prevent bending of the card due to these components having different heights, the electronic card according to an embodiment of the present invention may be made into a flat card shape by manufacturing a middle core sheet which has the same thickness as the tallest component so as to store the components.

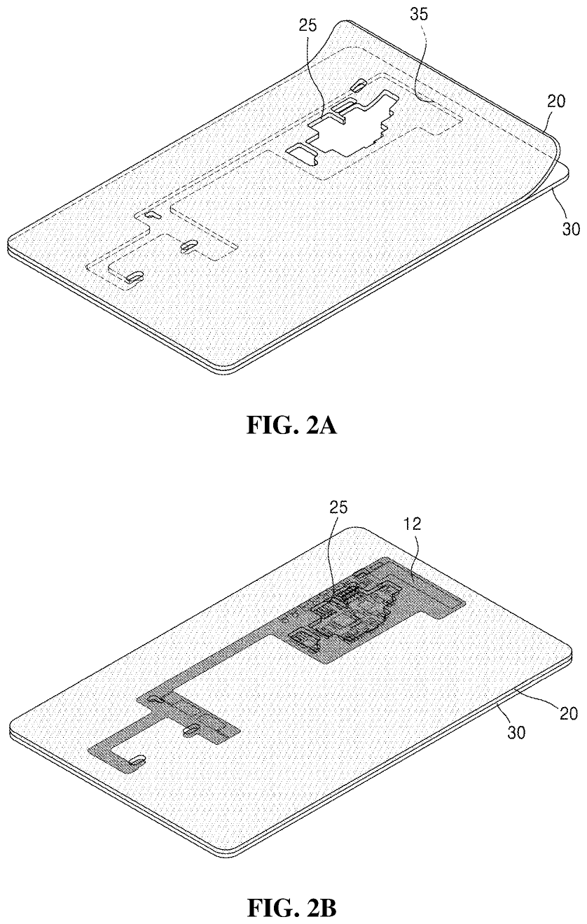

Referring to FIG. 1, the electronic module 12 may be mounted to a lower core sheet on the bottom side, and it may be implemented that the electronic module 12 is stored by being covered with the middle core sheet with respect to the contact terminal 11. Even though the electronic module 12 is mounted by the lower core sheet on the bottom side and the middle core sheet on the top side, it may be implemented that the contact terminal 11 is exposed to the outside and connected with a contact portion of an IC chip mounted in an IC coupling groove 13. This method for storing the electronic module 12 will be described in more detail with reference to FIGS. 2A to 4B.

In the existing electronic card, there has been a problem in that components in the electronic card hardly withstand high temperature and high pressure while manufactured and are thus damaged during processing. In an effort to solve this problem, the present invention has manufactured and employed a thermosetting epoxy resin sheet. The thermosetting epoxy resin sheet does not shrink even when laminated compared to PVC constituting an existing card, and is thus suitable for manufacturing electronic cards. As it has been implemented that a middle core sheet 20 and a lower core sheet 30 made of such a material are to store electronic circuits and components thereon, it has been implemented that an electronic card may be manufactured without damaging the electronic components and the circuits. Also, as the problems of shrinkage and component damages are solved, it becomes possible to manufacture the electronic card by stacking all sheets with a large area sheet, and there is an effect that mass production is easily achieved.

FIG. 2A shows a front surface of a core sheet of an electronic card according to an embodiment of the present invention. The core sheet serves as some sheets provided in the center of the electronic card to accommodate the electronic module 12, and there may be provided a middle core sheet 20, a lower core sheet 30, and the electronic module 12.

The core sheet of FIG. 2A is illustrated as a shape in which the lower core sheet 30 and the middle core sheet 20 are overlapped, and the lower core sheet 30 may include an electronic module storage portion 35 for storing the electronic module 12. It may be implemented that the electronic module storage portion 35 is the same as the edge shape of the electronic module 12 and has a form of an opening portion capable of accommodating the electronic module 12. The middle core sheet 20 may include a component storage portion 25 for storing electronic components disposed on the electronic module 12. Here, the component storage portion 25 may be formed so as to store a thick component having a height equal to or greater than a certain height among components of the electronic module 12. In other words, the height of the component storage groove 25 may be the same as the height of the tallest component in the electronic module 12.

In an embodiment, the middle core sheet 20 may be made of thermosetting epoxy resin films (epoxy glass cloth laminated sheets) and formed to a thickness of about 0.35 mm. The component storage portion 25 may be automatically shaped using a CNC milling machine and processed to correspond to the component position and component exterior of the electronic module, and a reference hole may be processed to a diameter of 3 mm.

In an embodiment, the lower core sheet 30 may be made of thermosetting epoxy resin films (epoxy glass cloth laminated sheets) and formed to a thickness of about 0.1 mm. An aqueous adhesive is applied to the top of the lower core sheet 30, and a milling process is performed, thus making it possible to form the electronic module storage portion 35 of which upper and lower portions are penetrated inside edges formed corresponding to the electronic module as shown in FIG. 2A. The processing and shaping of the electronic module storage portion 35 may be performed automatically by using a CNC milling machine, the electronic module storage portion 35 may be processed to a shape corresponding to the exterior of the electronic module 12, and a reference hole may be processed to a diameter of 3 mm.

After the electronic module is stored in the middle core sheet 20 and the lower core sheet 30 described above, high-temperature high-pressure laminating may be performed to make a single core sheet (e.g., an inlay sheet).

FIG. 2B shows a front surface of a core sheet to which an electronic module of an electronic card according to an embodiment of the present invention is mounted. First, the electronic module 12 may be mounted in the electronic module storage portion 35 of the lower core sheet 30. As described above, the electronic module storage portion 35 has the same shape so that the electronic module 12 is stored in the lower core sheet 30, enabling mounting to the the electronic module storage portion 35 and fixing to the lower core sheet 30. In an embodiment, a fixing member for connecting the electronic module 12 and the lower core sheet 30 may be used to fix the electronic module 12.

Next, the middle core sheet 20 may be placed, stacked, and attached on the lower core sheet 30 in which the electronic module 12 is mounted. At this time, the lower core sheet 30 and the middle core sheet 20 may be embodied as a large area sheet and may include a plurality of reference holes on the side portions thereof, and it may be implemented that the sheets to be stacked accurately aligned through the reference holes. Also, the middle core sheet 20 may be aligned and stacked so that the contact terminal 11 is exposed through the component storage portion 25. When such a core sheet is stacked, the core sheet is formed in such a shape that the middle core sheet 12 is overlapped on the lower core sheet 30 as illustrated in FIG. 2B, and is formed in such a shape that some components of the electronic module 12 are exposed through the component storage portion 25 which is an opening portion of the middle core sheet 20.

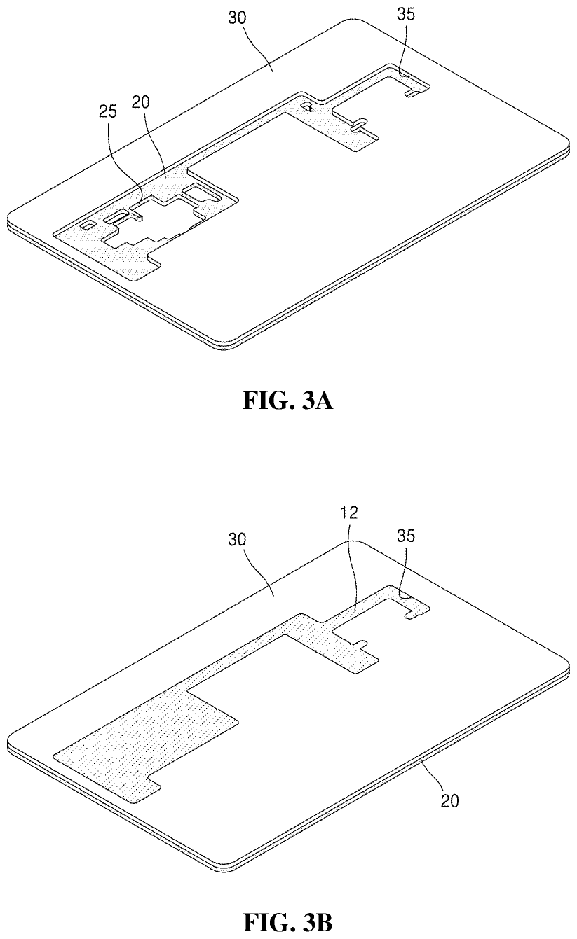

FIG. 3A shows a rear view of a core sheet of an electronic card according to an embodiment of the present invention, and FIG. 3B shows a rear surface of a core sheet to which an electronic module of an electronic card according to an embodiment of the present invention is mounted. When the core sheets described through FIGS. 2A and 2B are viewed from the rear sides, they can be shown as in FIGS. 3A and 3B, respectively.

FIG. 3A shows a state where the lower core sheet 30 and the middle core sheet 20 are attached without the electronic module 12, and is a drawing for explaining the electronic module storage portion 35 and the component storage portion 25. As described above, the electronic module storage portion 35 may be formed in such a shape that the upper and lower portions thereof are penetrated inside the edges formed corresponding to the electronic module. On the internal position of the electronic module storage portion 35, the component storage portion 25 may be formed so that some components (e.g., tall components) of the electronic module 12 are exposed.

FIG. 3B shows the rear surface of the core sheet in which the electronic module of the electronic card are mounted, and as illustrated, the electronic module 12 may be stored in the electronic module storage portion 35 formed in the lower core sheet 30. In the electronic module 12, an electronic circuit and a contact terminal are formed by etching a copper plate on a thin film, and the thickness of the thin film may be the same as that of the lower core sheet 30. In an embodiment, a fixing member (e.g., an adhesive) may be additionally used to store and fix the electronic module 12 in the electronic module storage portion 35 of the lower core sheet 30.

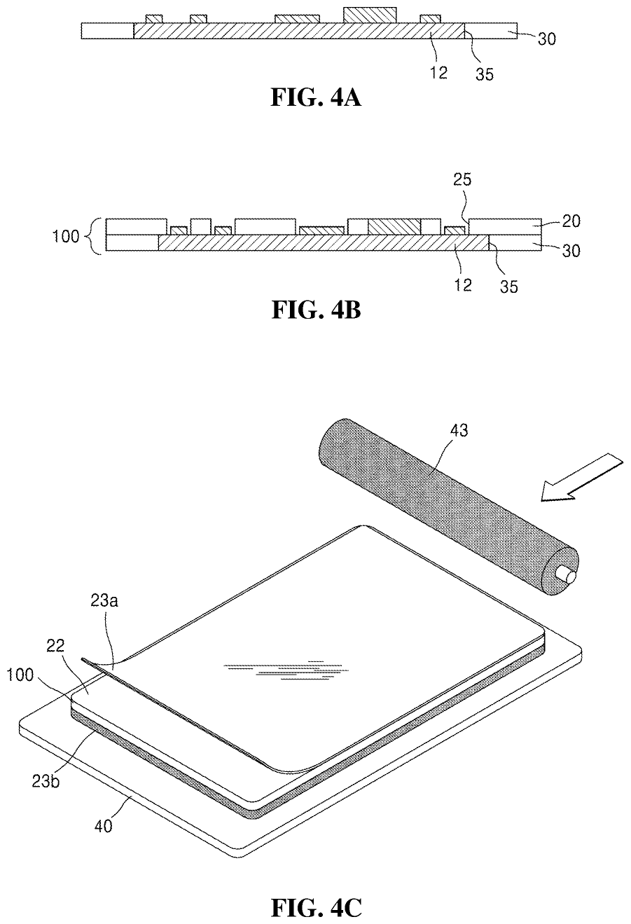

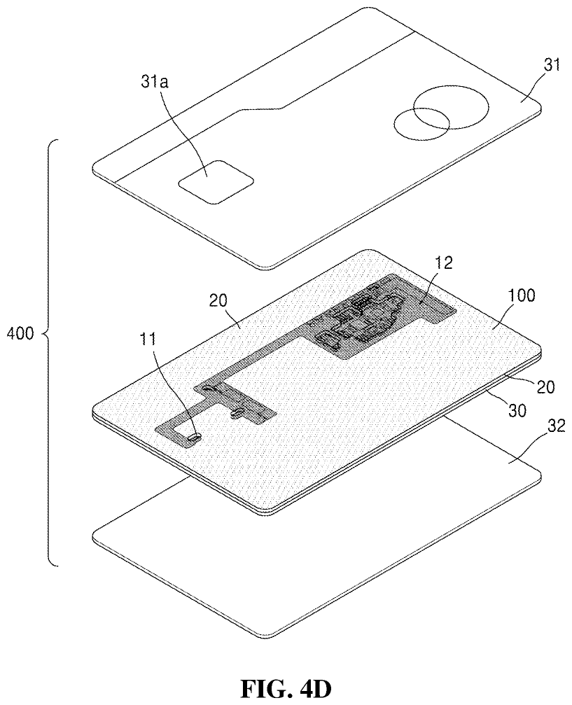

FIG. 4A shows a cross-section of a lower core sheet to which an electronic module of an electronic card according to an embodiment of the present invention is mounted. As described in FIGS. 3A and 3B, the electronic module 12 may be mounted in the electronic module storage portion 35 formed in the lower core sheet 30. The thin film of the electronic module 12 may be embodied with the same thickness as the lower core sheet 30, and the electronic circuits and components disposed in the electronic module 12 may appear to respectively have protruding shapes with different heights.

FIG. 4B shows a cross-section of a core sheet to which an electronic module of an electronic card according to an embodiment of the present invention is mounted. As illustrated in FIG. 4B, the electronic circuits and components of the electronic module 12 may have predetermined thicknesses, and the middle core sheet 20 including the component storage portion 25 so as to accommodate such components may be stacked on the top surface of the lower core sheet 30. The component storage portion 25 is formed such that the components penetrate, and it may be implemented that, in a space except for a region where the components are disposed, the middle core sheet 20 and the lower core sheet 30 are bonded.

FIG. 4C shows a planarization step in a manufacturing method for an electronic card according to an embodiment of the present invention. The middle core sheet 20 and the lower core sheet 30 attached to each other are subjected to high-temperature high-pressure laminating to form an inlay sheet 100 (a core sheet). Then, as illustrated in FIG. 4C, a transparent glass 40 and a release paper 23b are stacked on the bottom, a photo-curable resin 22 is applied to the top of the release paper 23b, the inlay sheet 100 is stacked on the top, and a photo-curable resin is applied to the the top of the inlay sheet 100. As the photo-curable resin used in the above step, a resin is used which is reacted and cured by ultraviolet (UV) rays or electron beams (EB).

Next, a step may be performed, in which a release paper 23a is placed on the top of the transparent glass 40, the release paper 23b, and the inlay sheet 100, and one side is fixed by a gripper 42. A planarization step was performed, in which the transparent glass 40, the release paper 23b, the inlay sheet 100, and the release paper 23a are fixed on one side and pushed by a roller 43, and a photo-curable resin 22 is pressed flat to remove bubbles, thereby bringing the release papers 23a and 23b into close contact with the top and bottom surfaces of the inlay sheet 100.

As a subsequent process, a step may be performed, in which a transparent glass 40 is also placed on the top of the inlay sheet 100, and light is emitted to the top and bottom of the inlay sheet 100, thereby curing the photo-curable resin 22. At this time, as the light emitted to the inlay sheet 100, ultraviolet (UV) rays or electron beams (EB) are emitted to cure the photo-curable resin within a short time, and the release paper 23a attached to the inlay sheet 100 is formed of a transparent sheet so as to allow light to pass therethrough.

Then, a step may be performed, in which the upper and lower release papers 23a and 23b are separated from the inlay sheet 100 in a state where, as the photo-curable resin 22 is cured, the electronic module 12 stored therein is integrally fixed to inner guide grooves (for example, the electronic module storage portion 35 and the component storage portion 25) of the inlay sheet 20.

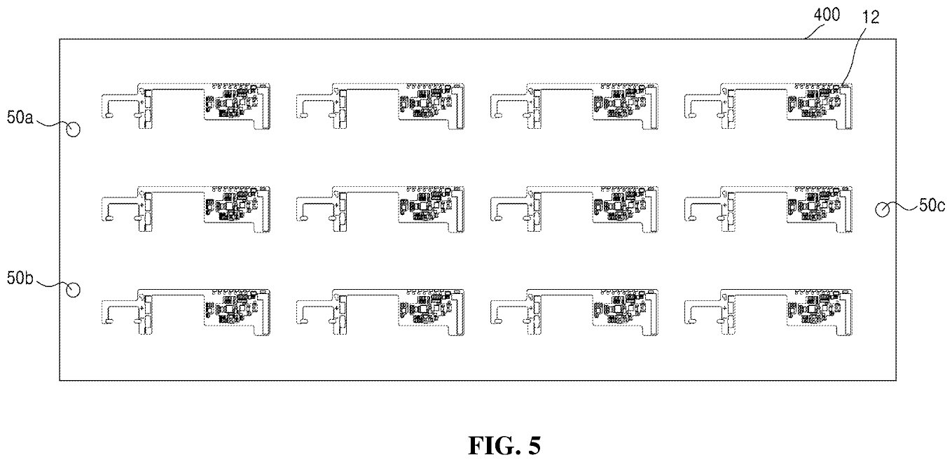

Next, FIG. 4D shows a configuration of stacked sheets in an electronic card according to an embodiment of the present invention. A step may be performed, in which a lower printing paper 32 is stacked on the same jig plate as three reference holes (50a, b, and c in FIG. 5), the inlay sheet 100 is stacked thereon, and an upper printing paper 31 is stacked thereon and attached to each other. The lower printing paper 32, the inlay sheet 100, and the upper printing paper 31, which are attached to each other, are subjected to high-temperature high-pressure laminating to complete the manufacture of the electronic card. At this time, the upper printing paper 31 may include an IC coupling portion 31a for attaching an IC chip, and it is implemented that contact between terminals is established through the contact terminal 11 exposed from the inlay sheet 100 during IC coupling.

FIG. 5 shows a mass production process in a manufacturing method for an electronic card according to an embodiment of the present invention. The above-described inlay sheet 100 and sheets such as the release paper and the printing paper may be embodied as large area sheets for mass production, and the sheets may be milled to form a plurality of reference holes 50a, 50b, and 50c. The large area sheet may be embodied to mount electronic modules disposed at predetermined positions as illustrated in FIG. 5. In this drawing, there is depicted a large area sheet including twelve electronic cards. Each of the sheets may be aligned to the reference holes 50a, 50b, and 50c when stacked, the sheets may be stacked on a jig plate and subjected to high-temperature high-pressure laminating, and the sheets may be formed into one coupled sheet through the laminating.

In this embodiment, an example in which three reference holes 50a, 50b, and 50c are formed on both sides of the inlay sheet 100 is illustrated, but the present invention is not limited thereto, and a plurality of reference holes may be formed at appropriate positions for fixing the sheet.

Next, after the inlay sheet 100 is formed, the transparent glass 40 and the release paper 23b are stacked on the bottom, the photo-curable resin is applied on the release paper 23b, and then the inlay sheet 100 are stacked thereon, the photo-curable resin 22 is applied on the inlay sheet 100, and thereafter the release sheet is placed on the top and fixed by the gripper (see FIG. 4C). After the planarization step is conducted through the roller 43 and the photo-curable resin is cured by irradiation with ultraviolet rays or electron beams, the upper and lower release papers 23a and b may be separated. At this time, the release papers 23a and 23b are embodied as a sheet made of a transparent material such that light is transmitted therethrough during the irradiation with the ultraviolet rays or electron beams.

Thereafter, the lower printing paper 32, the inlay sheet 100, and the upper printing paper 31 may be subjected to high-temperature high-pressure laminating on the same jig plate as the three reference holes 50a, 50b and 50c to thereby complete the sheet stacking process of the electronic card.

In an embodiment, when the sheet stacking process of the electronic card is completed, the cards may be individually separated one by one from the large area sheet including the plurality of cards through an NC cutting step.

In the existing electronic card, there has been a problem in that components in the electronic card hardly withstand high temperature and high pressure and are thus damaged during processing. In order to solve this problem, the present invention has employed a thermosetting epoxy resin sheet independently invented, and as it has been implemented that a middle core sheet and a lower core sheet made of such a material are to store electronic circuits and components thereon, it has been implemented that an electronic card may be manufactured without damaging the electronic components and the circuits. The thermosetting epoxy resin sheet does not shrink even when laminated compared to PVC constituting an existing card, and is thus suitable for manufacturing electronic cards. By employing such a material, it becomes possible to manufacture the electronic card by stacking all sheets with a large area sheet, and there is an effect that mass production is easily achieved.

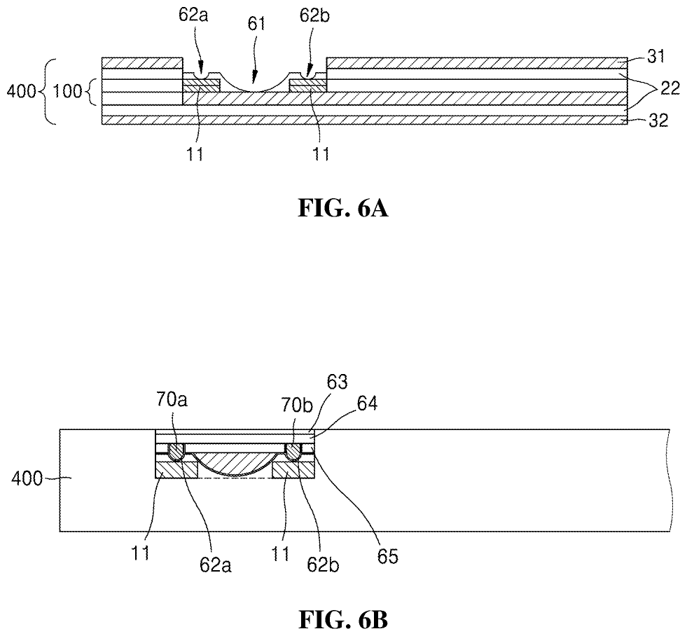

FIGS. 6A and 6B show a COB insertion process in a manufacturing method for an electronic card according to an embodiment of the present invention. A chip on board (COB) is a module including an IC chip and a contact terminal for connecting an external module, and the COB mounted to the card is embodied in a molded form so as to mount the chip on the rear surface thereof, and thus a portion of the rear surface may be embodied in a protruding shape. Therefore, a coupling groove to which the COB is mounted may be embodied in a shape corresponding to a rear surface protrusion so as to accommodate the rear surface protrusion. The COB mounted to the electronic card of the present invention may include a plating section 63, a copper plate 64, and a lower polyimide (PI) 65 (see FIG. 6B).

In an embodiment, the COB insertion process may be performed after the large area sheet stacking process and the individual card cutting process. As illustrated in FIG. 1, when the upper printing paper or the like is mounted to the electronic card 10, the IC coupling groove 13 is formed through milling, and the IC coupling groove 13 may be embodied such that the contact terminal 11 is exposed.

In an embodiment, referring to FIG. 6A, after the photo-curable resins 22 are applied to the top and bottom of the inlay sheet 100 including the middle core sheet, the lower core sheet, and the electronic module, the lower printing paper 32 and the upper printing paper 31 may be attached thereto. The IC coupling groove 13 is then formed through a milling process, and the IC coupling groove 13 may include a first coupling groove 61 for storing the rear surface of the COB and second coupling grooves 62a and 62b for exposing the contact terminal 11.

Next, paste adhesives 70a and 70b containing a conductive metal may be inserted into the second coupling grooves 62a and 62b through which the contact terminal 11 is exposed, and it is implemented that, when the COB is mounted to the coupling groove 13, the copper plate 64 of the COB is connected to the contact terminal 11 through the conductive paste adhesives 70a and 70b applied to the second coupling grooves 62a and 62b.

Through such a COB insertion process, it is possible to connect the electronic card and the COB through the conductive paste without direct connection between a separate antenna coil and an electronic component, thereby improving the process efficiency and facilitating the production of the electronic card. In addition, the contact area is larger than that in the direct contact of the antenna, thereby making it possible to reduce the defect rate and maximizing the production efficiency.

While the present invention has been described with reference to the embodiment illustrated in the drawings, it is will be understood by those skilled in the art that various modifications and equivalent other embodiments are possible therefrom. Accordingly, the actual technical protection scope of the present invention should be defined by the technical idea of the appended claims.

1. An electronic card comprising: an electronic module which is configured to comprise an electronic circuit and a contact terminal on a thin film and comprises one or more electronic components; a lower core sheet which comprises an electronic module storage portion for storing the electronic module in a shape corresponding to an outer peripheral shape of the electronic module; and a middle core sheet which is stacked on the top of the lower core sheet storing the electronic module, comprises a component storage portion for storing some or all of the one or more electronic components provided in the electronic module, and is configured to have a sheet thickness equal to a thickness of a tallest component among the electronic components.

2. The electronic card of claim 1, wherein the lower core sheet and the middle core sheet are made of a thermosetting epoxy resin.

3. The electronic card of claim 1, wherein the middle core sheet is stacked on the top of the lower core sheet such that a contact terminal of the electronic module is exposed through the component storage portion.

4. The electronic card of claim 1, wherein the middle core sheet and the lower core sheet are arranged so as to be aligned and completely overlapped by a jig through a plurality of reference holes formed in side portions thereof, and the middle core sheet and the lower core sheet comprising the electronic module form an inlay sheet through a laminating process at high temperature and high pressure.

5. The electronic card of claim 4, further comprising: a photo-curable resin applied on the top of the inlay sheet; and one or more printing papers attached above and below the inlay sheet.

6. The electronic card of claim 4, further comprising: a thermosetting resin applied to the top of the inlay sheet; and one or more printing papers attached above and below the inlay sheet.

7. The electronic card of claim 1, further comprising an IC chip mounted in an IC coupling groove so as to be connected to the contact terminal of the electronic module, wherein the IC coupling groove is formed by milling a surface of an upper printing paper and comprises a first coupling groove for accommodating a molding portion protruding from a rear surface of the IC chip and a second coupling groove milled to expose the contact terminal, and wherein, when mounted, the IC chip is connected to the contact terminal through a conductive paste adhesive inserted into the second coupling groove.

8. A method for manufacturing an electronic card, the method comprising the steps of:
forming an electronic circuit and a contact terminal on a thin film and mounting one or more electronic components, thereby forming an electronic module;
storing the electronic module in a lower core sheet, wherein the electronic module is stored in an electronic module storage portion having a shape corresponding to an outer peripheral shape of the electronic module; and
stacking a middle core sheet on the top of the lower core sheet storing the electronic module,
wherein, in the step of stacking the middle core sheet, the middle core sheet is stacked by using a component storage portion formed, so as to penetrate the middle core sheet, in a shape capable of storing some or all of the one or more electronic components provided in the electronic module, and a thickness of the middle core sheet is configured to be equal to a thickness of a tallest component among the electronic components.

9. The method of claim 8, wherein the lower core sheet and the middle core sheet are made of a thermosetting epoxy resin.

10. The method of claim 8, wherein the middle core sheet is stacked on the top of the lower core sheet such that a contact terminal of the electronic module is exposed through the component storage portion.

11. The method of claim 8, wherein the step of stacking the middle core sheet further comprises arranging the sheets so as to be aligned and completely overlapped by a jig through a plurality of reference holes formed in side portions thereof, wherein the middle core sheet and the lower core sheet comprising the electronic module form an inlay sheet through a laminating process at high temperature and high pressure.

12. The method of claim 11, further comprising the steps of: stacking a transparent glass and a release paper on the bottom of the inlay sheet and applying a photo-curable resin on the top of the release paper; applying a photo-curable resin on the top of the inlay sheet and stacking a release paper and then rolling the same; placing a transparent glass on the top of the release paper and emitting light to the top and bottom of the inlay sheet to cure the photo-curable resins; and separating the release papers and the transparent glasses on the top and bottom.

13. The method of claim 12, further comprising the steps of: attaching an upper printing paper to the top and a lower printing paper to the bottom so as to be aligned to a plurality of reference holes formed in the inlay sheet; and laminating the inlay sheet, to which the upper printing paper and the lower printing paper are attached, at high temperature and high pressure, thereby forming an electronic card sheet.

14. The method of claim 13, further comprising a step of mounting an IC chip in an IC coupling groove so as to be connected to the contact terminal of the electronic module,
wherein the IC coupling groove is formed by milling a surface of the upper printing paper and comprises a first coupling groove for accommodating a molding portion protruding from a rear surface of the IC chip and a second coupling groove milled to expose the contact terminal, and wherein, when mounted, the IC chip is connected to the contact terminal through a conductive paste adhesive inserted into the second coupling groove.
